(19) United States
(12) Patent Application Publication
(10) Pub. No.: US 2016/0036368 A1
(43) Pub. Date: Feb. 4, 2016

(54) SYSTEM AND METHOD OF CONTROLLING PARALLEL INVERTER POWER SUPPLY SYSTEM

(71) Applicant: Innovus Power, Inc., Freemont, CA (US)

(72) Inventor: John MCCALL, Freemont, CA (US)

(73) Assignee: Innovus Power, Inc., Freemont, CA (US)

(21) Appl. No.: 14/812,719

(22) Filed: Jul. 29, 2015

Related U.S. Application Data
(60) Provisional application No. 62/030,357, filed on Jul. 29, 2014.

(51) Int. Cl. H02P 27/06

(52) U.S. Cl. CPC H02P 27/06

(57) ABSTRACT

A method of controlling a pair of inverters connected in parallel and providing power to a motor. The speed of the motor is adjusted by varying the amplitude or frequency of the voltage supplied by each of the inverters to the motor. The method includes providing a system controller for controlling the frequency of the voltage supplied by each of the inverters. The frequency or amplitude setpoint of the voltage provided by each of the inverters is changed by sending a command signal from the system controller to each of the inverters in order to change the speed of the motor. The frequency or amplitude setpoint is controlled by a slew rate limiter.

### CROSS-REFERENCE TO RELATED APPLICATIONS

The present application claims priority to and the benefit of U.S. Provisional Patent Application No. 62/030,357, filed Jul. 29, 2014. The foregoing provisional application is incorporated by reference herein in its entirety.

### BACKGROUND

Variable speed motor operation is desirable in many applications. By varying motor speed, a variety of benefits may be achieved, including reduced energy consumption, longer component life, elimination of components such as gearboxes and transmissions, etc. Unfortunately, the most common and economical types of electric motors, such as synchronous and induction machines, operate at essentially constant speed when connected to a fixed frequency AC supply, such as a conventional power distribution grid or the output of a conventional fixed speed engine-generator set. As a result, it is increasingly common to drive such motors with inverters whose output voltage and frequency can be varied to achieve variable motor speed. These inverters are commonly known as variable speed drives (VSDs), variable frequency drives (VFDs) or adjustable speed drives (ASDs).

In some situations it is desirable to power a single motor with multiple inverters whose outputs are connected in parallel. The use of multiple inverters may be desirable for many different reasons such as, for example: to provide redundant power supplies, to provide sufficient power when the motor's power requirements exceed the output available from a single inverter, or to provide improved overall system efficiency. Examples of parallel power supplies are disclosed in U.S. Pat. Nos. 6,802,679; 7,145,266 and 7,327,111 (all incorporated by reference herein). This application discloses improved control for such systems.

### SUMMARY

According to an embodiment disclosed herein, a method of controlling a pair of inverters connected in parallel and providing power to a motor is provided. In the method, the speed of the motor is adjusted by varying the amplitude or frequency of the voltage supplied by each of the inverters to the motor. The method includes providing a system controller for controlling the frequency of the voltage supplied by each of the inverters. The frequency or amplitude setpoint of the voltage provided by each of the inverters is changed by sending a command signal from the system controller to each of the inverters thereby resulting in a change of the speed of the motor. The change in the frequency or amplitude setpoint is controlled by a slew rate limiter.

According to another disclosed embodiment, a system of providing power to a motor from a pair of inverters connected in parallel is provided. The inverters are controlled by a system controller. The speed of the motor is adjusted by varying the amplitude or frequency of the voltage supplied by each of the inverters to the motor. Each of the inverters is configured to receive a signal from the system control commanding a change in either the amplitude or frequency setpoint of the voltage supplied by the inverter. Each of the inverters includes a slew rate limiter to limit the change in the voltage to ensure that each of the inverters continues to supply power to the motor.

### BRIEF DESCRIPTION OF THE DRAWINGS

Features, aspects and advantages of the present invention will become apparent from the following description and the accompanying exemplary embodiments shown in the drawings, which are briefly described below.

FIG. 1A is a graph of frequency setpoint verus time that shows the communication delay between the initiation of the command signal and the change in the frequency setpoints of a pair of inverters.

FIG. 1B is a graph of the difference in frequency setpoint of the pair of inverters versus time.

FIG. 2A is a graph showing percent of power capacity being delivered by each of the pair of inverters versus frequency.

FIG. 2B is a graph showing the total power being delivered by the pair of inverters versus frequency.

FIG. 2C is a graph showing the percent of power imbalance (i.e., difference in power) between the pair of inverters versus frequency.

FIG. 3A is a graph showing the frequency setpoint of the inverters versus time.

FIG. 3B is a graph of the difference of frequency set point versus time.

FIG. 4A is a graph showing percent of power capacity being delivered by each of the pair of inverters versus frequency.

FIG. 4B is a graph showing the total power being delivered by the pair of inverters versus frequency.

FIG. 4C is a graph showing the percent of power imbalance (i.e., difference in power) between the pair of inverters versus frequency.

FIG. 5 is a block diagram of an exemplary power supply system for a pump.

FIG. 6 is a block diagram of an exemplary power supply system for a pump.

### DETAILED DESCRIPTION

One example of a system that utilizes parallel inverters, is a system for providing power to an electric submersible pump (ESP) used in an artificial lift system for oil production. In such a system, a pump with an electric motor is installed at the bottom of an oil well to lift oil to the surface. In oil production, redundancy is highly desirable for all components because any loss of oil production due to a failed component results in a high economic cost. Although it is not technically feasible to install redundant pumps and motors in the well, if the pump motor is driven by e.g. two parallel inverters, each of which can drive the motor at e.g. 80% of its rated power, then a failure in either drive (i.e., inverter) will not cause more than a partial loss of production.

A variety of methods exist for controlling multiple motor drive inverters connected in parallel, including using one central controller to directly control the power stages of all the inverters. Another method is precisely synchronizing the inverters using a dedicated cable. Yet another method of controlling the inverters is to allow a controller for each the inverter to control lower-level functions such as power transistor switching, but performing higher level motor control functions such as speed and flux regulation using a central controller. All of these control methods rely on some form of fast (e.g., greater than 100 Hz) and time-deterministic communication between the various inverters and controllers. Such communications add cost and complexity to the system. Many systems employ System Control And Data Acquisition (SCADA) systems that update at a rate of 1 Hz or less and use non-time-deterministic communication protocols such as Modbus. It is highly desirable to control parallel VFDs in such a system without additional hardware or major software changes.

For many electric motors such as, for example, induction motors and some kinds of synchronous motors, variable speed operation can be achieved using an open-loop, constant voltage and frequency (V/Hz) control. In this open-loop constant V/Hz control, both motor speed and optimal terminal voltage are assumed to be directly proportional to electrical frequency. Small variations in motor speed due to induction motor slip are neglected. In practice it is common to deviate slightly from truly constant V/Hz by, for example, applying proportionally higher voltage at very low frequencies in order to overcome stator resistance, or constant voltage at frequencies above the rated frequency. However, the motor control is still essentially open-loop. An outer control loop may be applied to such a system in order to, for example, fine tune motor speed or control a variable of the driven system, such as pump output pressure. Such an outer control loop may be quite slow without risking system stability.

Inverters, especially those with approximately sinusoidal voltage output waveforms, may be operated in parallel using voltage and frequency droop control that are similar to the droop controls employed with synchronous generators with automatic voltage regulators. Typically, frequency droop is associated with real power while voltage droop is associated with reactive power. Some real or simulated output impedance may be required at the output of each inverter to enable droop control.

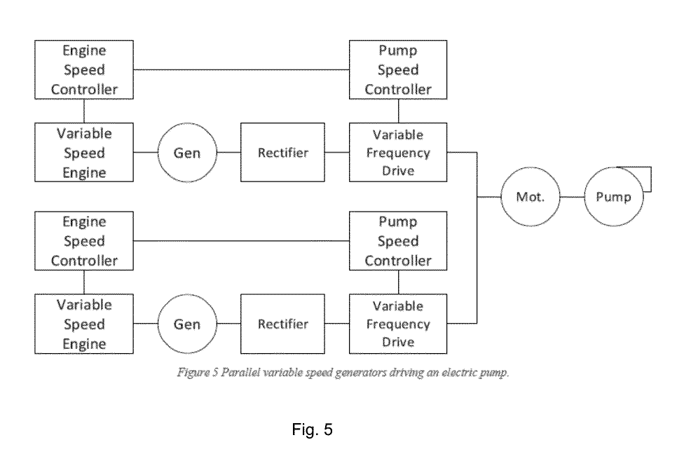

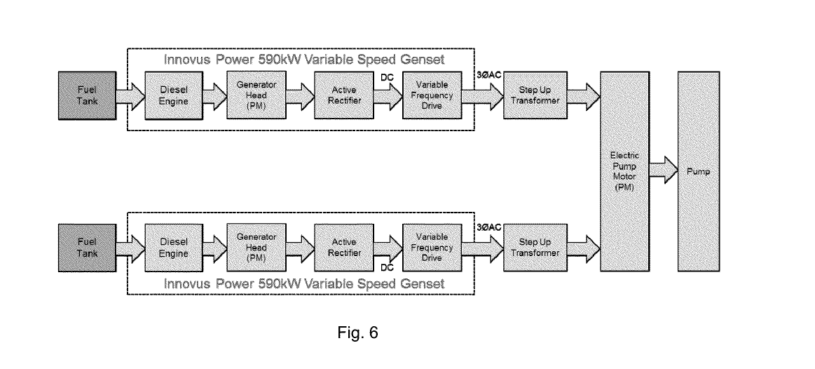

This application discloses a system of controlling two or more variable frequency, variable voltage inverters (such as motor drives) connected in parallel to provide power to a load (e.g., a variable speed motor). At any given nominal frequency and voltage setpoint, the inverters are controlled using voltage and frequency droop to achieve equal real and reactive loading of each inverter. The inverters share a common frequency setpoint which is determined by a central or system controller. They also share a common voltage setpoint, which may be determined by the system controller or derived independently by each inverter controller, e.g. as a lookup table or function of frequency setpoint. FIGS. 5 and 6 show exemplary embodiments of such a system for providing power to a pump.

One important figure of merit for any control system is the speed with which the system settles into an equilibrium state after a disturbance or change in conditions. Several different but interrelated parameters such as, for example, settling time, system time constant, or controller bandwidth, may be used to describe (or provide an indication of) this speed. For certain systems, parallel, droop-controlled inverters may reach equilibrium within tens of milliseconds following a disturbance that moves the inverters out of an equilibrium state.

The primary challenge in paralleling variable frequency inverters via droop occurs when changing setpoints (e.g., voltage or frequency setpoints). In particular, a transient condition in which two inverters are set to substantially different setpoints may cause highly uneven sharing of real and reactive load, or in the worst case may cause one inverter to trip on overload even though the other is unloaded. Such a condition may arise if relatively slow, non-time-deterministic communications are used. For example, if each inverter's communications update at a rate of 20 Hz, then an unequal setpoint may persist for up to 50 milliseconds. Control via a conventional SCADA system may cause even larger delays.

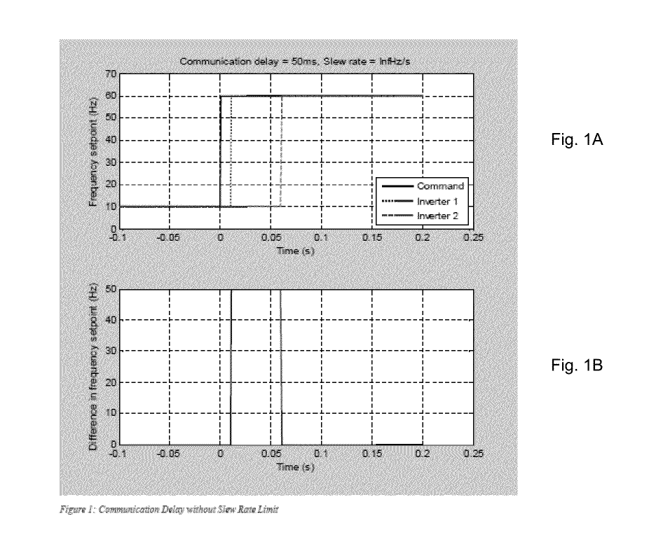

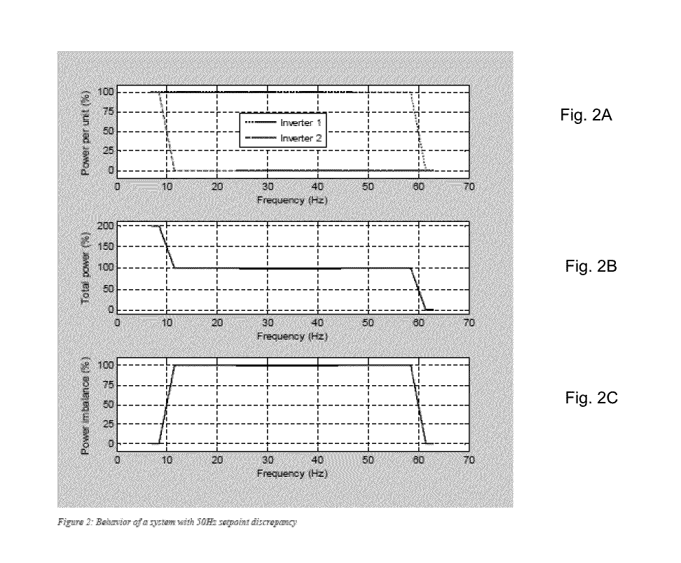

FIGS. 1A and 1B illustrate the delay described above. As shown in FIGS. 1A and 1B, for example, the system commands a change in nominal frequency setpoint from 10 Hz to 60 Hz. The first inverter's setpoint changes almost instantaneously, but the second inverter's setpoint does not change for another 50 ms. The result is a 50 Hz discrepancy in the setpoints of the two inverters, during the delay period (i.e., 50 ms). The result of this discrepancy in the setpoints, assuming typical droop curves, is shown in FIGS. 2A-2C. The first inverter is immediately fully loaded, and may trip (i.e., shut down) on overload before the second inverter delivers any power.

In addition, if the frequency setpoint changes faster than the droop controls can react, any slight difference in the dynamic behavior (i.e., transient behavior) of the inverters may also lead to one inverter being overloaded. Such a difference in dynamics may be caused e.g. by normal variation in manufactured components. The improved system and method described herein, solves these problems by applying a slew rate limiter or low-pass filter to the setpoint input of each inverter connected in parallel. The bandwidth or rate of this filter is set to meet the following two criteria: (1) any changes in setpoint must be made slower than the bandwidth of the droop controls (the droop controls must be able to “track” the changing setpoint with negligible lag time); and (2) the maximum change in setpoint over one full communication cycle must be less than the range of the droop curve at each setpoint, i.e. even if the inverters' setpoints are misaligned by a full communication cycle, the inverters must still share load to some degree. The slew rate limiter can be implemented using a filter, op amp or other suitable hardware.

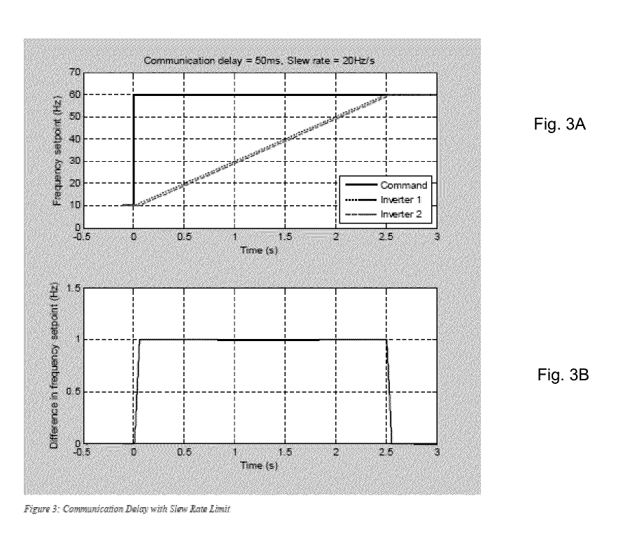

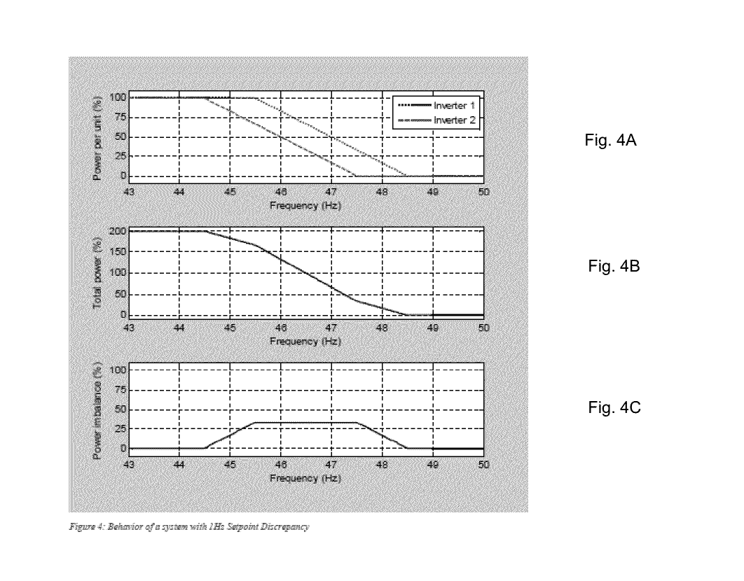

FIGS. 3A-3B and FIGS. 4A-4C illustrate the effect of implementing a limit in the rate of change of the frequency setpoint, for example, a limit of 20 Hz/s. The two inverters' setpoints track each other much more closely and never differ by more than 1 Hz. As a result, the two inverters' droop curves always overlap and no large discrepancies in delivered power occur. (FIG. 4 uses frequency setpoints of 47 Hz and 46 Hz as an example; the behavior is essentially the same at e.g. 32 Hz and 31 Hz or 60 Hz and 59 Hz) In many if not most real-world applications, such a rate limit is not detrimental to the performance of the overall system. In fact, such a filter or rate limited is desirable in many applications for reasons not relating to the inverter such as for example: abrupt changes in the speed of pumps can cause undesirable effects such as cavitation, stalling, and pressure surges (water hammer); “smoothing” any changes in the power drawn by the inverters can increase the stability of their power sources, especially in microgrids and generator-based systems; abrupt speed or torque changes, especially in long and/or flexible drivelines, can cause rotor dynamic problems in rotating equipment; abrupt changes in driving frequency may cause motors to draw excessive current, produce excessive or insufficient torque, and/or (in the case of synchronous motors) lose synchronization, especially in systems with high inertia. FIGS. 3 and 4 disclose a limit placed on the change in the frequency setpoint for the inverters. A similar system can be employed that also (or alternatively) includes place a limit on the slew rate of the voltage setpoint.

Thus, the disclosed system employs more than one inverter for providing power to a variable speed motor, wherein the inverters have changing frequency and voltage setpoints. The system employs droop control is used to share real and reactive load between inverters at any given setpoint. The frequency and/or voltage setpoint is filtered and/or rate limited so that the change in the setpoint occurs at a slower rate than the bandwidth of the droop controller. Alternatively, the frequency and/or voltage setpoint is filtered and/or rate limited so that the change in the setpoint occurs at a slower rate than the droop controller's communication speed.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is important to note that the systems and methods disclosed herein are illustrative and exemplary only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosure herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments.

What is claimed is:

1. A method of controlling a pair of inverters connected in parallel and providing power to a motor, wherein the speed of the motor is adjusted by varying the amplitude or frequency of the voltage supplied by each of the inverters to the motor, the method comprising the steps of:
providing a system controller for controlling the voltage supplied by each of the inverters;
changing the frequency or amplitude setpoint of the voltage provided by each of the inverters by sending a command signal from the system controller to each of the inverters in order to change the speed of the motor;
wherein the change in the frequency or amplitude setpoint is controlled by a slew rate limiter.

2. The method of claim 1, wherein each of the inverters includes droop control for adjusting the frequency of the voltage supplied by the inverter based on the real power provided by the inverter, wherein for a given increase in real power the frequency of the voltage supplied by the inverter decreases, and wherein the step of changing the frequency setpoint of each of the inverters is limited by the slew rate limiter so that the frequency setpoint does not change more than the bandwidth of the frequency droop control to ensure that each of the inverters is supplying real power.

3. The method of claim 1, wherein each of the inverters includes droop control for adjusting the amplitude of the voltage supplied by the inverter based on the reactive power supplied by the inverter, wherein for an increase in reactive power the amplitude of the voltage supplied by the inverter decreases, and wherein the step of changing the amplitude setpoint is limited by the slew rate limiter so that the amplitude setpoint does not change more than the bandwidth of the droop control to ensure that each of the inverters is supplying reactive power.

4. A method of controlling a pair of inverters connected in parallel and providing power to a motor, wherein the speed of the motor is adjusted by varying the amplitude or frequency of the voltage supplied by each of the inverters to the motor, the method comprising the steps of:
providing a system controller for controlling the voltage supplied by each of the inverters;
changing the frequency or amplitude setpoint of the voltage provided by each of the inverters by sending a command signal from the system controller to each of the inverters in order to change the speed of the motor;
wherein the change in the frequency or amplitude setpoint is controlled by a low-pass filter.

5. The method of claim 4, wherein each of the inverters includes droop control for adjusting the frequency of the voltage supplied by the inverter based on the real power provided by the inverter, wherein for a given increase in real power the frequency of the voltage supplied by the inverter decreases, and wherein the step of changing the frequency setpoint of each of the inverters is limited by the low-pass filter that the frequency setpoint does not change more than the bandwidth of the frequency droop control to ensure that each of the inverters is supplying real power.

6. The method of claim 4, wherein each of the inverters includes droop control for adjusting the amplitude of the voltage supplied by the inverter based on the reactive power supplied by the inverter, wherein for an increase in reactive power the amplitude of the voltage supplied by the inverter decreases, and wherein the step of changing the amplitude setpoint is limited by the low-pass filter so that the amplitude setpoint does not change more than the bandwidth of the droop control to ensure that each of the inverters is supplying reactive power.

7. A method of controlling a pair of inverters connected in parallel and providing power to a motor, wherein the speed of the motor is adjusted by varying the amplitude or frequency of the voltage supplied by each of the inverters to the motor, the method comprising the steps of:
controlling the voltage supplied by each the inverters using droop control, wherein the amplitude of the voltage supplied by the inverter is controlled based on the reactive power supplied by the inverter, wherein for an increase in reactive power the amplitude of the voltage supplied by the inverter decreases, and wherein the frequency of the voltage supplied by the inverter is controlled based on the real power provided by the inverter, wherein for an increase in real power the frequency of the voltage supplied by the inverter decreases, and wherein the droop controls are based on setpoints for voltage amplitude and frequency;
providing a system controller for controlling the voltage supplied by each of the inverters;
changing the droop control used by each of the inverters by changing frequency setpoint of the voltage provided by each of the inverters by sending a command signal from the system controller to each of the inverters.

8. The method of claim 7, wherein the change in the frequency setpoint is controlled by a slew rate limiter

9. The method of claim 8, wherein the slew rate limiter includes a filter.

10. The method of claim 7, further comprising the step of changing the droop control used by each of the inverters by changing the amplitude setpoint of the voltage provided by each of the inverters by sending a command signal from the system controller to each of the inverters.

11. The method of claim 7, further comprising the step of changing the droop control used by each of the inverters by changing the amplitude setpoint of the voltage based on a change in the frequency setpoint.
